(19) United States
(12) Patent Application Publication
(10) Pub. No.: US 2009/0210786 A1
(43) Pub. Date: Aug. 20, 2009

(54) IMAGE PROCESSING APPARATUS AND IMAGE PROCESSING METHOD

(75) Inventor: Yuusuke Suzuki, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/356,912

(22) Filed: Jan. 21, 2009

Related U.S. Application Data
(60) Provisional application No. 61/029,871, filed on Feb. 19, 2008.

(51) Int. Cl. G06F 17/00; G06F 3/12

(52) U.S. Cl. 715/243; 358/1.15

(57) ABSTRACT

It is an object of the present invention to provide an image processing technique that can separately apply, concerning a document image including plural objects, appropriate image processing to each of the objects included in the document image. An image processing method for applying image processing to a document image including plural objects includes: discriminating to which of plural kinds of predetermined layouts a layout of objects in a correction target document image corresponds; selecting, on the basis of the discriminated layout, predetermined image processing associated with positions and types of the respective objects in the discriminated layout; and applying the image processing selected for the types of the respective objects to the respective objects corresponding to the types in the correction target document image.

### CROSS-REFERENCE TO RELATED APPLICATION

This application is based upon and claims the benefit of priority from U.S. provisional Application No. 61/029,871, filed on Feb. 19, 2008, the entire contents of which are incorporated herein by reference.

### TECHNICAL FIELD

The present invention relates to an image processing technique, and, more particularly to image processing for a document image in which a layout of display target objects such as characters and images are decided in advance.

### BACKGROUND

Conventionally, as a technique for improving an image quality of a scan image of a standard business document, there is known a technique for improving an image quality of a document image by switching and carrying out, when a paper document described according to a standard format is scanned and digitized, scanning procedures of scan processing according to characters and images (figures, pictures, photographs, ruled lines, and the like other than the characters) in a document using known layout information (JP-A-8-335249).

There is also an image processing technique for selectively applying image processing such as smoothing, coloring, painting, color conversion, trimming, and black extraction on the basis of position and area information designated in advance (JP-A-8-293032).

However, in the conventional image processing techniques explained above, image processing applied to a document image is carried out on the basis of only layout information (position information) of a standard document. Therefore, the same processing is applied to display target objects arranged in certain places of the document image irrespective of contents of the display target object.

Therefore, in some case, inappropriate image processing is applied to the display target objects. As a result, there are partially unclear places in an obtained document image.

### SUMMARY

It is an object of an embodiment of the present invention to provide an image processing technique that can separately apply, concerning a document image including plural objects, appropriate image processing to each of the objects included in the document image.

In order to solve the problem, an image processing apparatus according to an aspect of the present invention is an image processing apparatus that applies image processing to a document image including plural objects. The image processing apparatus includes: a layout discriminating unit that discriminates to which of plural kinds of predetermined layouts a layout of objects in a correction target document image corresponds; a processing selecting unit that selects, on the basis of the layout discriminated by the layout discriminating unit, predetermined image processing associated with positions and types of the respective objects in the discriminated layout; and a correction processing unit that applies the image processing selected for the types of the respective objects by the processing selecting unit to the respective objects corresponding to the types in the correction target document image.

An image processing apparatus according to another aspect of the present invention is an image processing apparatus that combines plural objects to form a document image. The image processing apparatus includes: a layout-information acquiring unit that acquires information concerning layouts of objects in a document image that should be formed; a resolution-enhancement processing unit that enhancing a first resolution of a first object to a second resolution of a second object, which is higher than the first resolution; and a combination processing unit that combines the second object and the first object with enhanced resolution into a single document image on the basis of the information acquired by the layout-information acquiring unit.

An image processing method according to still another aspect of the present invention is an image processing method for applying image processing to a document image including plural objects. The image processing method includes: discriminating to which of plural kinds of predetermined layouts a layout of objects in a correction target document image corresponds; selecting, on the basis of the discriminated layout, predetermined image processing associated with positions and types of the respective objects in the discriminated layout; and applying the image processing selected for the types of the respective objects to the respective objects corresponding to the types in the correction target document image.

An image processing method according to still another aspect of the present invention is an image processing method for combining plural objects to form a document image. The image processing method includes: acquiring information concerning layouts of objects in a document image to be formed; enhancing a first resolution of a first object to a second resolution of a second object, which is higher than the first resolution; and combining the second object and the first object with enhanced resolution into a single document image on the basis of the acquired information.

An image processing program according to still another aspect of the present invention is an image processing program for causing a computer to execute an image processing method for applying image processing to a document image including plural objects. The image processing program causes the computer to execute processing for: discriminating to which of plural kinds of predetermined layouts a layout of objects in a correction target document image corresponds; selecting, on the basis of the discriminated layout, predetermined image processing associated with positions and types of the respective objects in the discriminated layout; and applying the image processing selected for the types of the respective objects to the respective objects corresponding to the types in the correction target document image.

An image processing program according to still another aspect of the present invention is an image processing program for causing a computer to execute an image processing method for combining plural objects to form a document image. The image processing program causes the computer to execute processing for: acquiring information concerning layouts of objects in a document image to be formed; enhancing a first resolution of a first object to a second resolution of a second object, which is higher than the first resolution; and combining the second object and the first object with enhanced resolution into a single document image on the basis of the acquired information.

### DESCRIPTION OF THE DRAWINGS

FIG. 1 is a system diagram for explaining a specific configuration of an image processing system according to a first embodiment of the present invention;

FIG. 2 is a functional block diagram for explaining an image processing apparatus 1a according to the first embodiment;

FIG. 3 is a diagram of an example of a data table that specifies a correspondence relation between positions and types of objects and predetermined image processing;

FIG. 4 is a diagram of an example of a setting screen displayed on a display unit 701;

FIG. 5 is a diagram for explaining an effect realized by applying image processing for improving visibility of a person's photograph area to a document image obtained by scanning a passport as an identification card;

FIG. 6 is a diagram of a document image obtained by scanning the passport with an image scanning unit 200;

FIG. 7 is a diagram of a document image subjected to image processing by the image processing apparatus 1a;

FIG. 8 is a flowchart of an example of a flow of processing (an image processing method) in the image processing apparatus 1a according to the first embodiment;

FIG. 9 is a diagram of an example of a document in which electronically created portions and hand-written portions are mixed;

FIG. 10 is a diagram of an example of an imprint image in a state in which visibility falls because the imprint is stored at low resolution;

FIG. 11 is diagram of an example of a file format in which data of a high-resolution image and data of a low-resolution image are mixed;

FIG. 12 is a functional block diagram for explaining a configuration of an image processing apparatus 1b according to a second embodiment of the present invention;

FIG. 13 is a diagram of an image object of an imprint portion scanned and stored at high second resolution;

FIG. 14 is a flowchart of an example of a flow of processing (an image processing method) in the image processing apparatus 1b according to the second embodiment;

FIG. 15 is a functional block diagram for explaining a configuration of an image processing apparatus 1c according to a third embodiment of the present invention;

FIG. 16 is a diagram of an example of a document written by a user;

FIG. 17 is a diagram of an example of contents notified by a notifying unit 112;

FIG. 18 is a flowchart of an example of a flow of processing (an image processing method) in an image processing apparatus 1c according to a third embodiment of the present invention; FIG. 19 is a conceptual diagram for explaining an image processing system according to a fourth embodiment of the present invention;

FIG. 20 is a functional block diagram for explaining a configuration of an image processing apparatus 1d according to the fourth embodiment;

FIG. 21 is a flowchart of an example of a flow of processing (an image processing method) in the image processing apparatus 1d according to the fourth embodiment; and

FIG. 22 is a diagram of a configuration example of an image processing apparatus according to the present invention realized by a PC (Personal Computer).

### DETAILED DESCRIPTION

Embodiments of the present invention are explained below with reference to the accompanying drawings.

### First Embodiment

First, a first embodiment of the present invention is explained.

An image processing system according to the first embodiment is an image processing system that realizes a work flow for scanning, with a scanner or the like, a document such as a certificate described in a standard format to digitize and use the document.

There is known a job system that scans, in a job for registering an indefinite number of people in a cellular phone contract counter, an insurance contract counter, or the like, an identification card including a face photograph such as a driver's license or a passport and a signed and sealed application form and performs application and registration using data obtained by digitizing the identification card and the application form.

In the following explanation of the first embodiment, as an example, a signed and sealed application form and an identification card of an applicant attached to the application form are separately scanned, image processing is applied to two image data obtained by scanning the application form and the identification card, and the image data are stored in a database.

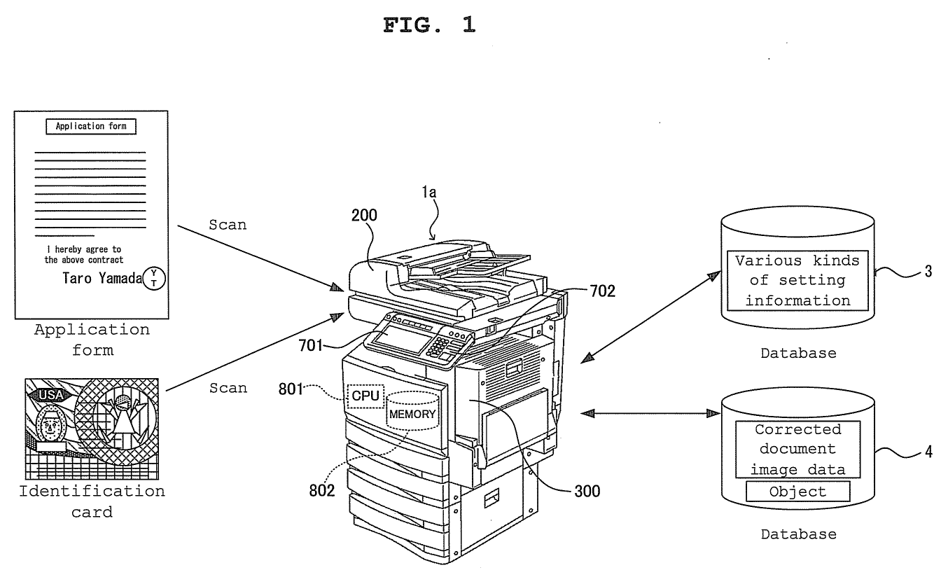

FIG. 1 is a system diagram for explaining a specific configuration of the image processing system according to the first embodiment. The image processing system according to this embodiment includes an image processing apparatus 1a including an image scanning unit 200 and an image forming unit 300, a database 3, and a database 4.

The image processing apparatus 1a, the database 3, and the database 4 can communicate with one another via a network such as the Internet, a LAN, or a WAN. A communication line connecting these apparatuses may be either a wired or wireless communication line.

Details of equipment configuring the image processing system shown in FIG. 1 are explained below.

The image processing apparatus 1a is realized by an MFP (Multi Function Peripheral) and includes an image scanning unit 200, a display unit 701, an operation input unit 702, an image forming unit 300, a CPU 801, and a memory 802. The image processing apparatus 1a has a role of applying image processing to image data of documents such as an application form and an identification card scanned by the image scanning unit 200 and image data acquired by the image processing apparatus 1a from other external apparatuses and a storage medium such as a flash memory.

The display unit 701 can include an LCD (Liquid Crystal Display), an EL (Electronic Luminescence), a PDP (Plasma Display Panel), or a CRT (Cathode Ray Tube).

The operation input unit 702 can include a keyboard, a mouse, a touch panel, a touchpad, or a graphics tablet.

Functions of the display unit 701 and the operation input unit 702 can be realized by a so-called touch panel display.

The CPU 801 has a role of performing various kinds of processings in the image processing apparatus 1a and has a role of realizing various functions by executing programs stored in the memory 802. The memory 802 can include a RAM (Random Access Memory), a ROM (Read Only Memory), a DRAM (Dynamic Random Access Memory), an SRAM (Static Random Access Memory), or a VRAM (Video RAM). The memory 802 has a role of storing various kinds of information and programs used in the image processing apparatus 1a.

The image forming unit 300 has a function of printing and outputting image data scanned by the image processing apparatus 1a, data subjected to image processing by the image processing apparatus 1a, data received by the image processing apparatus 1a from an external apparatus or a storage medium, and the like on a recording medium such as paper.

The database 3 has a role of a database for storing various kinds of information such as set values used in the image processing apparatus 1a.

The database 4 has a role of a database for storing and managing document image data subjected to image processing by the image processing apparatus 1a, character data and image data used in the image processing apparatus 1a, and the like.

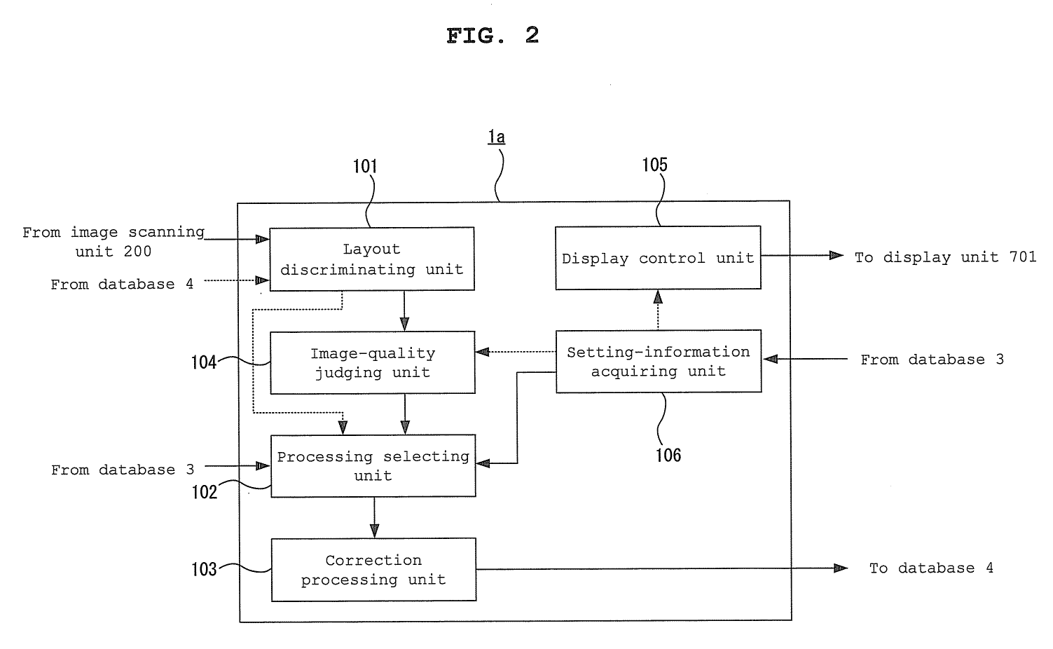

FIG. 2 is a functional block diagram for explaining the image processing apparatus 1a according to the first embodiment.

The image processing apparatus 1a according to the first embodiment includes a layout discriminating unit 101, a processing selecting unit 102, a correction processing unit 103, an image-quality judging unit 104, a display control unit 105, and a setting-information acquiring unit 106.

Details of functional blocks configuring the image processing apparatus 1a according to this embodiment are explained below.

First, the layout discriminating unit 101 acquires electronic data of a document image obtained by scanning an application form or an identification card as an original using the image scanning unit 200 and executes layout analysis on the document image. The layout analysis can be realized by a method of extracting an area considered to correspond to an object from the document image and analyzing a layout of the area (e.g., a method of analyzing the layout using the size of the scanned document image, an object shape included in the document image, and color data), a method of analyzing a layout of objects on the basis of information embedded as header information in data of the document image, a method of combining and carrying out the methods explained above, and the like. Layout judgment processing for the document image by the layout judging unit 101 is not limited to the processing explained above. The layout judgment processing may be realized by various publicly-known layout judgment techniques.

As a result of the layout analysis, the layout discriminating unit 101 discriminates a layout in the document image of display target objects such as a photograph image and text data extracted from the document image. The layout discriminating unit 101 discriminates to which of plural kinds of predetermined layouts (e.g., an application form layout and an identification card layout) prepared in advance the layout discriminated for the document image as explained above corresponds. Information concerning the plural kinds of predetermined layouts can be stored in, for example, the database 3.

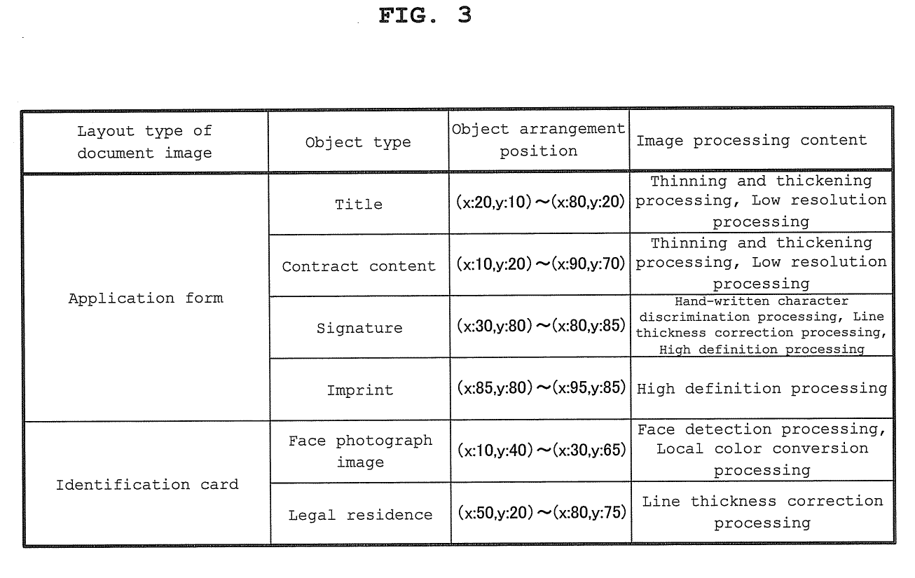

The processing selecting unit 102 selects, on the basis of the layout discriminated by the layout discriminating unit 101, predetermined image processing associated with positions and types of the objects in the discriminated layout. Information specifying a correspondence relation between the positions and the types of the objects and the predetermined image processing can be stored in, for example, the database 3. FIG. 3 is a diagram of an example of a data table that specifies the correspondence relation between the positions and the types of the objects and the predetermined image processing.

The “positions of the objects” correspond to positions and ranges on the document image of the display target objects such as an photograph image and characters (in FIG. 3, as an example, the positions of the objects are represented by a range (represented in %) from a position at a distance (represented in %) from the upper left corner of the document image) . The “types of the objects” corresponds to information indicating types of the display target objects, that is, indicating which of text data, photograph image data, and figure data the objects are.

Examples of the image processing include high definition processing, smoothing processing, noise removal processing, thinning and thickening processing, white balance correction processing, brightness correction processing, chroma correction processing, partial brightness correction processing, local color conversion processing, hand-written character discrimination processing, line thickness detection processing, face detection processing, and low resolution processing.

The “high definition processing” is processing for improving fineness of an area of a target object and improving visibility and sharpness. Basically, the high definition processing refers to processing for enhancing the resolution of a rendering area and increasing the number of pixels such that edges of objects are not spoiled in the rendering area. Specifically, examples of the high definition processing include a so-called super resolution technique (equivalent to a so-called image enhancement processing) and a technique realized by pixel increasing processing based on interpolation processing such as a bicubic method, a bicubic convolution method, and an interpolating method.

The “smoothing processing” is processing for smoothing edges in an image area having low scanner resolution and original resolution to improve clearness of characters and graphics.

The “noise removal processing” is processing for removing noise to improve clearness. Examples of the noise removal processing include filter processing for removing digital noise caused when a digital image is compressed and processing for replacing a portion corresponding to an area of dust, which is scanned when an original is scanned and digitized, with a base color.

The “thinning and thickening processing” is processing for correcting an unclear portion of a too-thick and deformed line to be clear with thinning processing and correcting an unclear portion of a too-thin line to be clear.

The “white balance correction processing” is processing for automatically correcting, if a display target object is photograph content, a white balance that affects attractiveness of the photograph content. Specifically, the white balance correction processing is processing for automatically correcting a white balance of a photograph object that fluctuates according to the environment during photographing (the sunlight or a fluorescent lamp, indoor or outdoor, etc.).

The “brightness correction processing” and the “chroma correction processing” are processing for automatically adjusting the brightness and the vividness of an entire photograph object to clearly show the photograph object. Specifically, the brightness correction processing and the chroma correction processing are processing for automatically correcting the brightness and the vividness of the photograph object on the basis of a histogram of the photograph object.

The “partial brightness correction processing” is, for example, processing for correcting only an area that is too dark or too bright and unclear. Specifically, the partial brightness correction processing is processing for applying pin-point brightness correction to a too-bright area or a too-dark area in a photograph on the basis of, for example, a photographing condition without spoiling clearness of other areas.

The “local color conversion processing” is processing for identifying a specific area (e.g., a face portion) in a document image with, for example, face detection processing and applying color conversion only to the specific area.

The “hand-written character discrimination processing” is processing for identifying a hand-written character highly likely to be too thin and invisible or deformed and improving visibility of a target hand-written character area.

The “line thickness correction processing” is processing for detecting deformation of a character or a hand-written character and a too-thin and unclear line area and correcting the character and the line area to have appropriate thickness.

The “face detection processing” is processing for detecting a face area that tends to be unclear in a backlight image or the like and partially correcting brightness for the detected face area to improve clearness of a face of a person.

The “low resolution processing” is processing for reducing resolution in an area corresponding to an object that can be easily restored to a high-quality state when necessary later (a sentence, a title sentence, or the like indicating predetermined contract content).

The correction processing unit 103 applies the image processing selected for the types of the objects by the processing selecting unit 102 to objects corresponding to types in correction target document images.

By adopting such a configuration, it is possible to correct each of plural display target objects, which are laid out in a document image in a predetermined layout, according to predetermined image processing associated in advance on the basis of factors such as importance on documents of the respective objects, easiness of image processing, and whether processing content of necessary image processing is empirically known, to thereby apply optimum image processing to the respective display target objects taking into account characteristics of the respective documents.

The image-quality judging unit 104 judges image qualities of the respective objects on the basis of at least one of luminance values and color values of pixels included in each of the plural objects included in the correction target document image and shapes of a part of the objects or the entire objects. It goes without saying that the image quality judgment processing by the image-quality judging unit 104 is not limited to the method explained above and may be realized by publicly-known various image-quality judging methods.

The processing selecting unit 102 can select, on the basis of a result of the judgment by the image-quality judging unit 104, an algorithm or processing parameters of image processing that should be applied to the objects. The processing selecting unit 102 can determine, on the basis of the result of the judgment by the image-quality judging unit 104, presence or absence of application of the image processing to the respective objects.

The “algorithm” means a procedure of processing applied to a display target object in correcting an image quality of the display target object. Specifically, for example, since contrast adjustment processing and chroma adjustment processing have different arithmetic procedures for processing image data, it can be said that the contrast adjustment processing and the chroma adjustment processing are kinds of processing having different algorithms.

The “processing parameters” mean variables and set values in applying image processing employing a certain algorithm to the display target object. Specifically, for example, a change for increasing or reducing the luminance of pixels, which form the display target object, by a certain degree (e.g., certain % from the luminance of original pixels) in density adjustment processing corresponds to a change of the processing parameters.

Consequently, for example, if contents (a processing algorithm and parameter set values) of image processing associated in default with an object included in a document image of a certain layout are inappropriate, it is possible to change the contents to appropriate processing contents according to an actual image quality state of the object.

The image quality judgment for the display target object by the image-quality judging unit 104 can be performed on the basis of parameters such as “resolution”, “frequency response”, “noise”, “tone characteristic”, “dynamic range”, “ratio of coincidence with a predetermined character or shape”, and “uniformity”.

Besides, the processing selecting unit 102 can select, on the basis of an image quality of a first object judged by the image-quality judging unit 104, an algorithm or processing parameters of image processing applied to a second object different from the first object.

With such a configuration, for example, if it is highly likely that an image quality (e.g., brightness and sharpness) of an object (e.g., a photograph of a construction site) arranged in a certain position of a document image is correlated with an image quality of another object (e.g., a photograph of another construction site) arranged in the same document image or another document image (e.g., it is highly likely that both the photographs are taken under the same photographing environment), it is possible to contribute to improvement of an image quality of the document image as a whole by selecting appropriate contents as processing contents of image processing applied to the other object. Concerning plural objects that are extremely highly correlated and obviously being subjected to the same image processing, it is possible to realize a reduction in an arithmetic load required for image quality judgment, processing selection, and the like and contribute to improvement of processing speed in the image processing apparatus by automatically applying the same image processing to the respective plural objects.

The processing selecting unit 102 may select, for a first object including at least one of a character, a sign, a line, and a figure included in a document image, processing for setting resolution lower than that of a predetermined second object having importance higher than that of the first object.

It can be said that the character, the sign, the line, the figure, the background, and the like are display target objects that can be relatively easily enhanced in resolution by image processing such as enhancement processing compared with a photograph image and the like. On the other hand, even if the enhancement processing is applied to the photograph image, a degree of an increase in resolution is limited. Therefore, it is preferable to acquire, in a state of as high resolution as possible, display target objects having high importance such as an imprint in a contract and a face photograph in an identification card.

Therefore, image processing for reducing resolution is applied to the objects such as the character, the sign, the line, and the figure that are easily restored to a high-quality state when necessary even if the objects are stored in a low-resolution state. Image processing for setting relatively higher resolution than that set by the image processing applied to the objects such as the character is applied to objects such as a photograph that are less easily restored to a high-quality state if the objects are stored in a low-resolution state and objects for which accuracy is required (important objects that need to be faithfully reproduced) because of importance thereof (or no image processing is applied to the objects). This makes it possible to realize a reduction in a data amount of a document image as a whole.

The correction processing unit 103 can embed, as “metadata”, image data having high resolution in a document image digitized at low resolution. Specifically, concerning a method of processing for embedding a high-resolution image in a document image by the correction processing unit 103, for example, if an “HDPhoto format” is selected as a data format, it is possible to adopt a method of embedding the high-resolution image as user-defined tag information. If a “JPEG image format” is selected, it is possible to adopt a method of embedding the high-resolution image as a comment in a header.

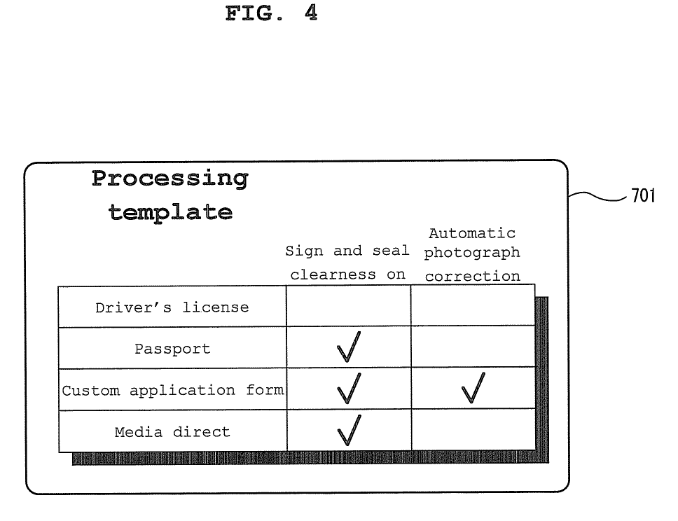

The display control unit 105 causes the display unit 701 to display a selection screen on which it is possible to select, for each of predetermined layouts, image processing that should be applied to objects included in a correction target document image. FIG. 4 is a diagram of an example of a setting screen displayed on the display unit 701. In the setting screen shown in the figure, it is possible to set whether two items “sign and seal clearness ON” and “automatic photograph correction” should be activated according to sources of documents and data of different layouts such as “driver's license”, “passport”, “custom application form”, and “media direct”.

The setting-information acquiring unit 106 acquires information concerning setting operation inputted by a user on the basis of contents of a user interface screen displayed by the display control unit 105. The information concerning the setting operation acquired by the setting-information acquiring unit 106 is stored in, for example, the database 3 or the database 4 such that the information can be read out when necessary.

The processing selecting unit 102 can select image processing set for respective objects on the basis of the information acquired by the setting-information acquiring unit 106 or the information stored in the database 3 or the database 4.

With such a configuration, the image processing apparatus 1a according to this embodiment realizes image processing for a document image including plural objects.

An example of specific processing in the image processing apparatus 1a according to this embodiment is explained below.

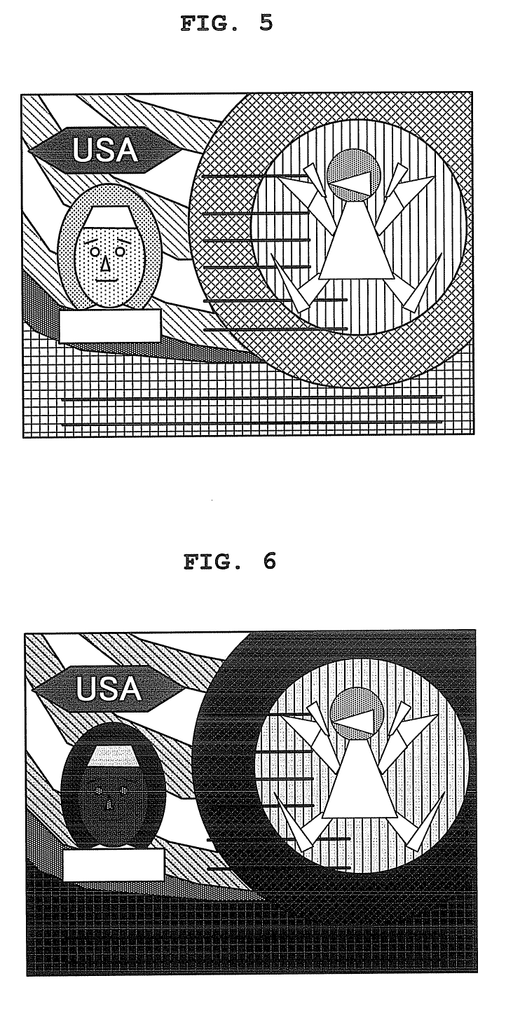

FIGS. 5 to 7 are diagrams for explaining an effect realized when image processing for improving visibility of a person's photograph area is applied to a document image obtained by scanning a passport as an identification card.

Many photographs attached to certificates are taken by an automatic machine for certificate photographs or taken by clerks not having professional knowledge in certificate-issuing agencies. Among the certificate photographs taken in this way, some photographs are not taken under satisfactory conditions and bright parts and dark parts thereof are unclear. FIG. 5 is a diagram of an image of a passport to be scanned. FIG. 6 is a diagram of a document image obtained by scanning the passport with the image scanning unit 200.

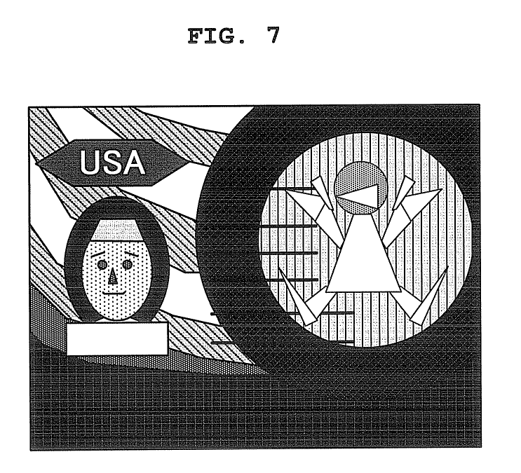

With the configuration according to this embodiment, concerning such a document image of a certificate including photograph image objects, it is possible to apply bright-part and dark-part correction processing to a specific area in a photograph image (e.g., an image area corresponding to a face portion in a face photograph). FIG. 7 is a diagram of a document image in a state in which local image processing is applied to an area of the face photograph by the image processing apparatus 1a.

A flow of processing in the image processing apparatus 1a according to the first embodiment is explained below.

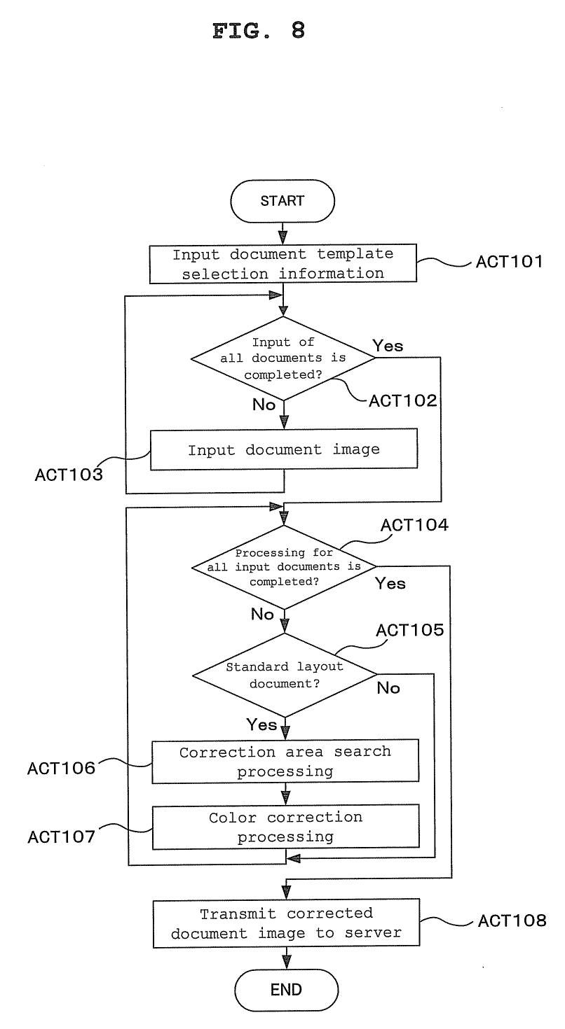

FIG. 8 is a flowchart of an example of a flow of processing (an image processing method) in the image processing apparatus 1a according to the first embodiment.

First, the user starts scanning of an identification card with the image scanning unit 200 in the image processing apparatus 1a (ACT 101). With this as a trigger, all images concerning a correction target document are inputted (ACT 102 and ACT 103).

If an inputted document image is an image of a document of a standard layout (ACT 105, Yes), processing for automatically discriminating brightness in a person's photograph area in the identification card is applied to this area (ACT 106). If the brightness requires image processing, the brightness (a color value) of the local area is corrected according to correction parameters corresponding to a range of a value of the brightness (ACT 107).

On the other hand, if it is discriminated that the inputted document image is not an image of the document of the standard layout (ACT 105, No), the image processing apparatus 1a does not perform the image processing.

If the image processing is applied to all the documents inputted as correction targets (ACT 104, Yes), document image data subjected to the image processing is transmitted to the database 4 and stored therein (ACT 108).

In this embodiment, as an example, the database 3 and the database 4 are arranged independently from the image processing apparatus 1a. However, the present invention is not always limited to this. It goes without saying that, for example, at least one of the database 3 and the database 4 can be integrated with the image processing apparatus 1a.

In the example explained in this embodiment, electronic data of a discrimination target document image in the layout discriminating unit 101 is scanned by the image scanning unit 200. However, the present invention is not always limited to this. It goes without saying that, for example, document image data transmitted from an external apparatus connected to the image processing apparatus 1a to be capable of communicating with each other or document image data stored in the database 4 in advance can be set as a discrimination target.

In this way, brightness adjustment for a portion in image objects included in a document image obtained by scanning is applied to the image objects in this way. This makes it possible to improve visibility of bright parts and dark parts in the image objects.

### Second Embodiment

A second embodiment of the present invention is explained below.

The second embodiment is a modification of the first embodiment explained above. In this embodiment, components having functions same as those of the sections explained in the first embodiment are denoted by the same reference numerals and signs and explanation of the components is omitted.

Documents to be stored in jobs include documents including hand-written signatures and seals on printed documents (documents in which electronically created portions and hand-written portions are mixed, etc.) such as a document created and printed on a computer, a complete hand-written document, a contract, and a slip. If such paper documents are digitized and managed, it is possible to reduce data volume and reduce cost for data storage by storing the document at low resolution.

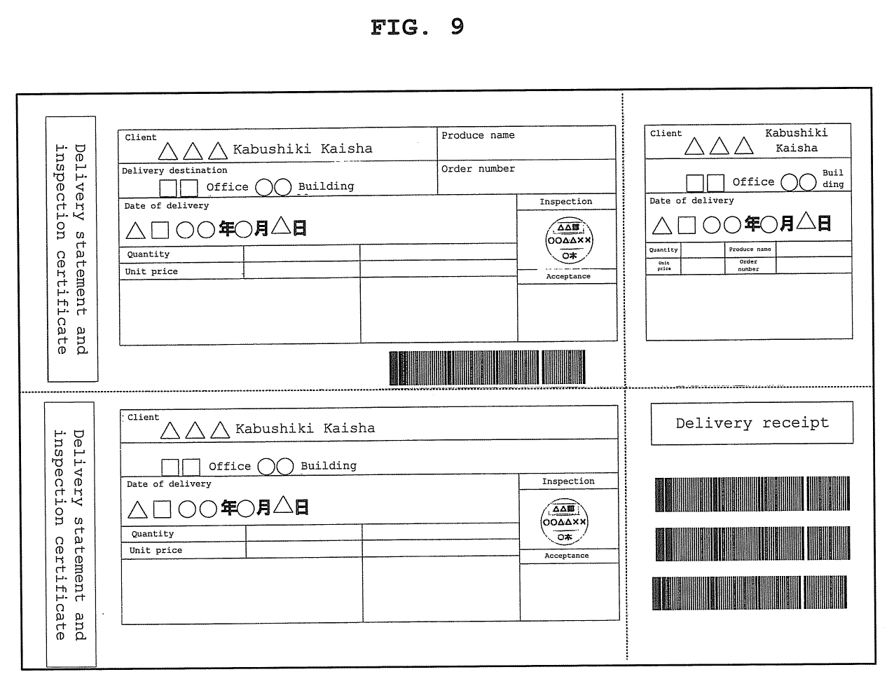

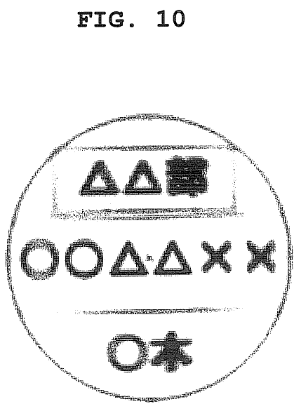

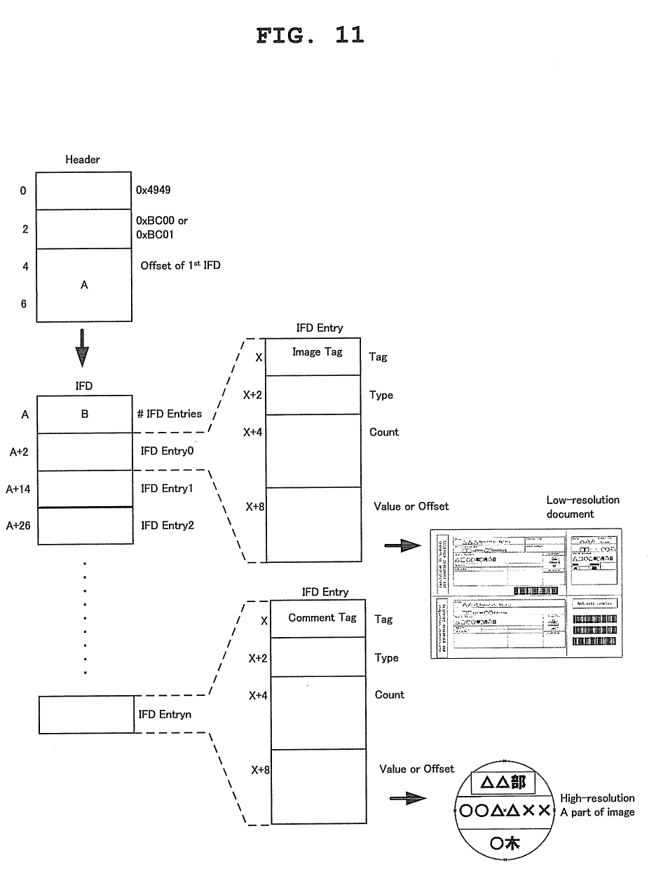

However, for example, if a document including a seal such as a date seal shown in FIG. 9 is stored at low resolution, in some case, an imprint of the seal portion is not, for example, entirely printed at uniform density and is partially blurred and visibility falls because of factors such as a material of a pad laid under paper (see, for example, FIG. 10).

Similarly, in some document including a hand-written portion, a hand-written character becomes thin depending on applied force or density fluctuates in the character. If such a document is digitized at low resolution by scanning, in some case, a low-density place in the character is averaged with a color of a base, the density further falls, and the character cannot be read. On the other hand, in order to prevent such a problem, if the entire paper document is digitized at high resolution, a data amount increases and cost for storage increases. Besides, there is also a system for applying identification processing to an entire document image and storing characters and images at different resolutions and with different compression systems. However, in some case, the system cannot be applied to documents in which characters and frames are close to each other such as hand-written characters, a seal including decorated characters, and a date seal. As another method, there is also a method of enhancing resolution with a so-called image enhancement processing in which a paper document is digitized as a low-resolution image in advance, and when referred to or copied, it is enhanced in resolution. However, in this case, concerning image areas of objects such as hard-copied characters and graphics, since the entire objects are printed at the same density, an external shape can be kept even if the image area is subjected to the image enhancement processing. However, blurred characters, seals, and the like may not be able to be restored.

In the following explanation of this embodiment, as an example, an application form signed by handwriting and sealed and an identification card of an applicant attached to the application form are separately scanned and two image data obtained by the scanning are combined to form one document image.

It is assumed that, as a premise, the processing selecting unit 102 selects, for a first object including at least one of a character, a sign, a line, and a figure included in a document image, processing for setting resolution lower than that of a predetermined second object (a signature, an imprint, etc.) having importance higher than that of the first object and the correction processing unit 103 applies the processing selected by the processing selecting unit 102 to the first object (for details, see the first embodiment).

Data of a first object subjected to correction processing for reducing resolution by the correction processing unit 103 and data of a second object subjected to correction processing to increase resolution to resolution higher than that of the first object (or resolution of original data is maintained) may be stored in the database 4 or the like as one data file in a data format in which data concerning the first and second objects are mixed. Alternatively, the first and second objects may be extracted from original document images and separately stored in the database 4 or the like in advance.

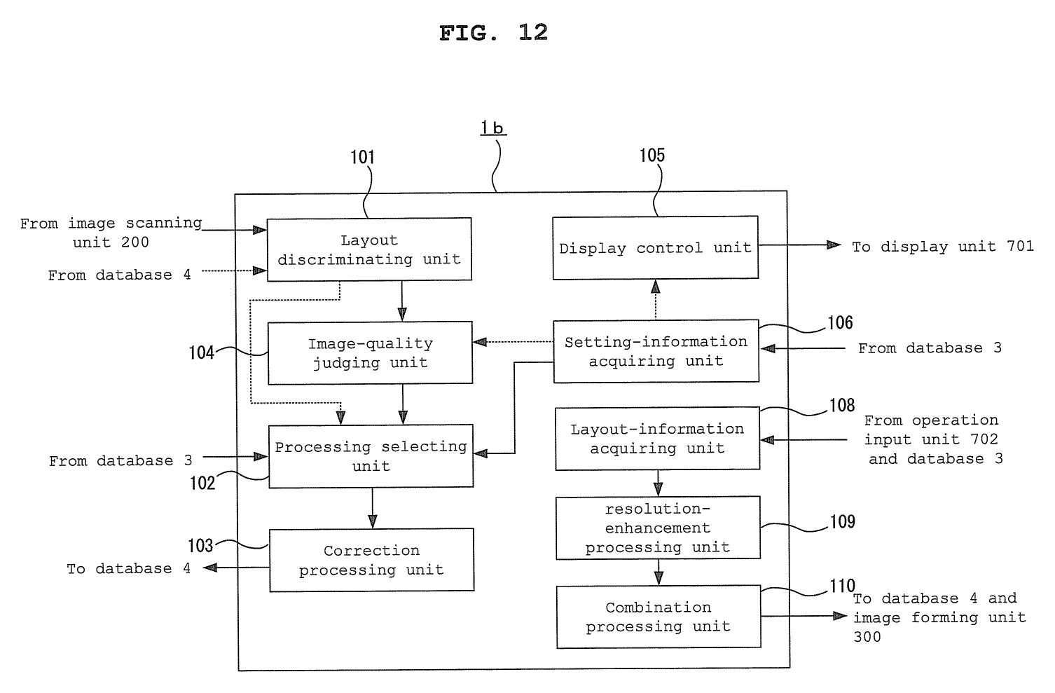

If the data format in which the data concerning the first and second objects are mixed is adopted, the correction processing unit 103 can, for example, embed image data having high resolution in a document image digitized at low resolution as “metadata”. Specifically, concerning a method of storing data generated by the correction processing unit 103, if the HDPhoto format is selected as a data format, a high-resolution image is inserted as user-defined tag information and, if the JPEG image format is selected, a high-resolution image is inserted as a comment in a header (see, for example, FIG. 11).

FIG. 12 is a functional block diagram for explaining a configuration of an image processing apparatus 1b according to the second embodiment. The image processing apparatus 1b according to the second embodiment further includes, in addition to the functions of the image processing apparatus 1a according to the first embodiment, a layout-information acquiring unit 108, a resolution-enhancement processing unit 109, and a combination processing unit 110.

Functions of the layout-information acquiring unit 108, the resolution-enhancement processing unit 109, and the combination processing unit 110 in the image processing apparatus 1b according to this embodiment are explained in detail.

The layout-information acquiring unit 108 acquires information concerning a layout of display target objects in document images to be combined by the image processing apparatus 1b. Examples of the information concerning the layout of the display target objects include types of display target objects arranged in a document and arrangement positions in the document of the display target objects (see, for example, FIG. 3). The layout-information acquiring unit 108 acquires, for example, on the basis of operation input of the user in the operation input unit 702 or on the basis of header information, layout information, and the like included in data files to be subjected to combination processing by the combination processing unit 110, information concerning a layout of document images to be combined.

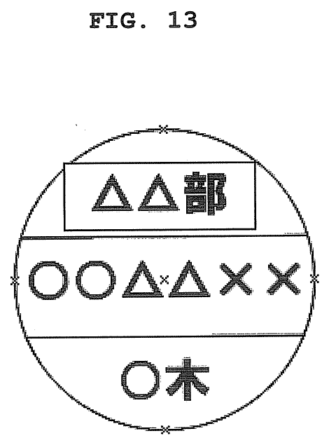

The resolution-enhancement processing unit 109 that enhancing a first resolution of a first object (e.g., 200 dpi) to a second resolution of a second object (e.g., 400 dpi), which is higher than the first resolution. FIG. 13 is a diagram of an example of an image object of an imprint portion scanned and stored at the high second resolution.

The combination processing unit 110 has a function of combining the second object and the first object enhanced in resolution by the resolution-enhancement processing unit 109 into a single document image on the basis of the information acquired by the layout-information acquiring unit 108.

The combination processing by the combination processing unit 110 can be realized by, for example, overwriting an image of an image area scanned and stored at high resolution by the image scanning unit 200 over an image area of a page image or the like enhanced in resolution by the resolution-enhancement processing unit 109 to form one document image.

Consequently, if an object having high resolution or less easily enhanced in resolution even by the enhancement processing or the like is stored with correction processing for reducing resolution prevented from being applied thereto as much as possible and with a high-resolution state kept, an image having high resolution as a document image as a whole and faithful to contents of an original image can be reproduced later when necessary.

As explained above, in the image processing apparatus 1b according to the second embodiment, it is possible to store, with a high quality, only a specific area in a standard layout. It is possible to store an area signed by hand writing or sealed as a high-quality storage area in a highly readable state by using this apparatus. It is possible to hold down management cost for data by storing, at low resolution, an area unnecessary to be stored with a high quality.

When the data digitized as explained above is referred to, even if the document is unclear in that state, it is possible to output the entire document in a high-resolution and highly readable state by smoothly enhancing the resolution of the area stored at low resolution with the image enhancement processing or the like and merging the area with the area stored at high resolution.

In this way, according to the second embodiment, it is possible to store, with a smaller data amount, electronic data of a paper document. When the stored electronic data is printed or displayed, it is possible to reproduce display target objects important in a document such as a signature and a seal when necessary (e.g., when readability of the document poses a problem).

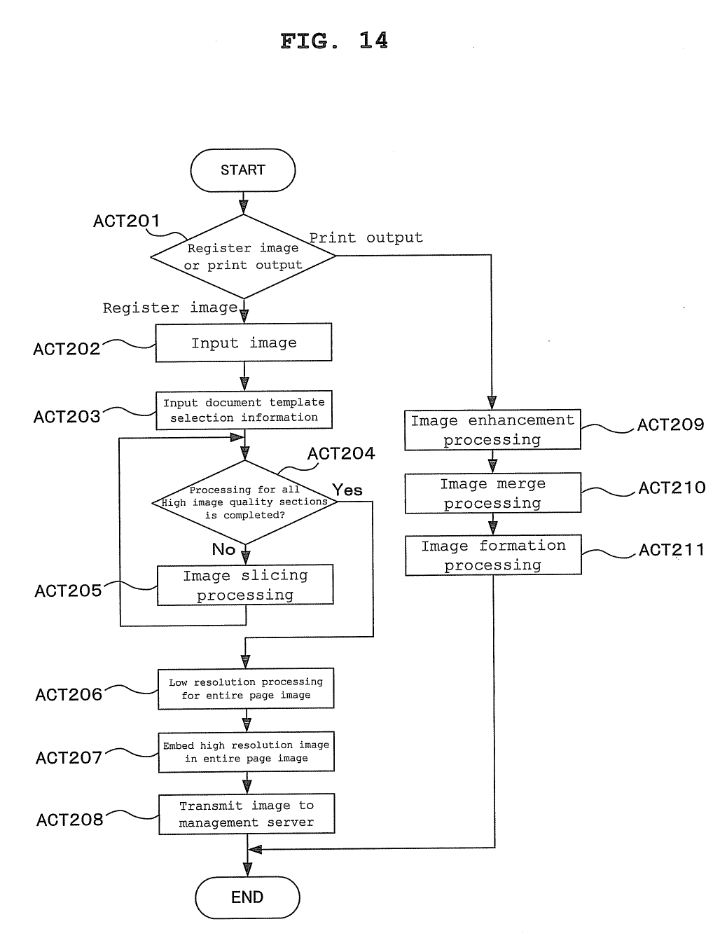

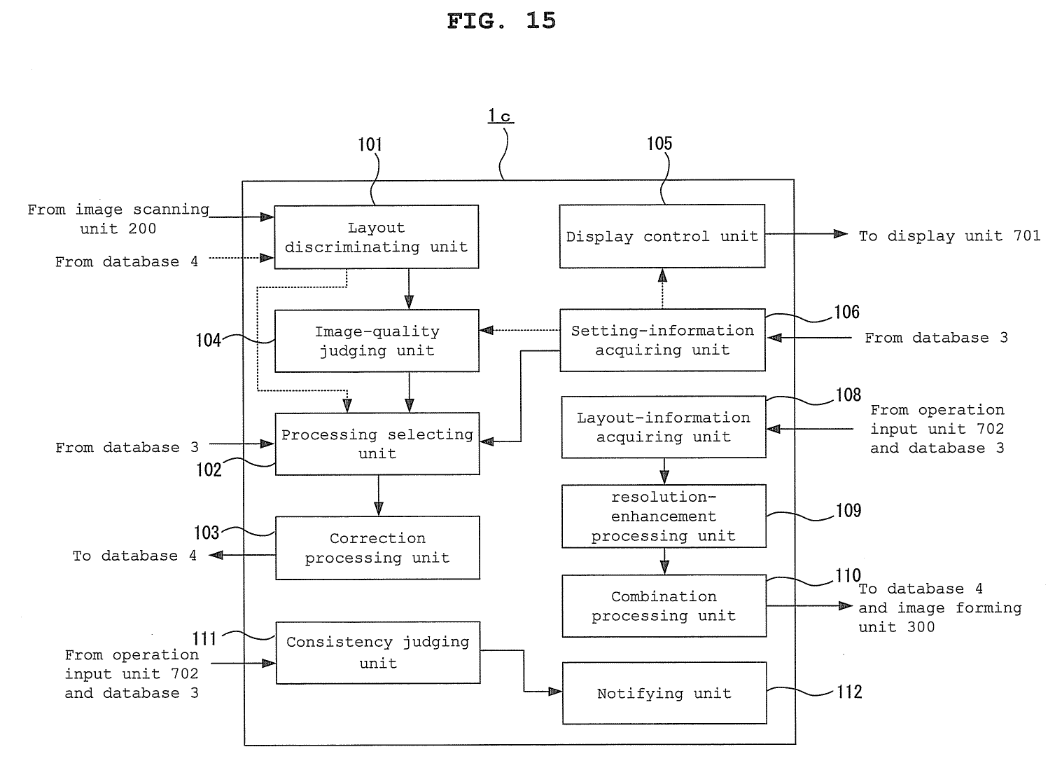

FIG. 14 is a flowchart of an example of a flow of processing (an image processing method) in the image processing apparatus 1b according to the second embodiment.

If a document image is registered in the database 4 (ACT 201, register an image), first, the image scanning unit 200 scans the document image (ACT 202).

Subsequently, it is discriminated to which of predetermined plural layouts a scanning target document corresponds (ACT 203). All objects that should be enhanced in quality included in the document image are sliced (ACT 204 and ACT 205). The objects sliced at this point maintain the resolution of the original document image.

Processing for reducing resolution is applied to the entire document image (ACT 206). Image data of objects stored at high resolution is embedded, as metadata or the like, in a page of the document image reduced in resolution (ACT 207).

The data in which the high-quality objects are embedded in this way is stored in, for example, the database 4 (ACT 208).

On the other hand, if the document is printed and outputted to a paper medium or the like (ACT 201, print output), the image enhancement processing (processing for enhancing resolution) is applied to a page image of a document image stored in a low-resolution state (ACT 209). A second object having high resolution embedded as metadata or the like and the page image (a first object) enhanced in resolution are merged (ACT 210).

Thereafter, the image forming unit 300 performs image formation processing on the basis of a document image merged as explained above (ACT 211).

### Third Embodiment

A third embodiment of the present invention is explained below.

The third embodiment is a modification of the second embodiment. In this embodiment, components having functions same as those of the sections explained in the first and second embodiments are denoted by the same reference numerals and signs and explanation of the components is omitted.

The third embodiment realizes correction easy for a user concerning misdescriptions such as mark mistakes in a scanning target document such as an application form.

FIG. 15 is a functional block diagram for explaining a configuration of the image processing apparatus 1c according to the third embodiment. The image processing apparatus 1c according to the third embodiment further includes, in addition to the functions of the image processing apparatus 1b according to the second embodiment, a consistency judging unit 111 and a notifying unit 112.

Functions of the consistency judging unit 111 and the notifying unit 112 in the image processing apparatus 1c according to this embodiment are explained in detail below.

The consistency judging unit 111 judges consistency of the arrangement of objects or rendered contents (described contents) in a correction target document image (e.g., a document image scanned by the image scanning unit 200 or a document image received from an external apparatus by the image processing apparatus 1c). Judgment rule information as a reference for judgment processing by the consistency judging unit 111 (information for consistency check specified for consistency of described contents in a document) is stored in, for example, the database 3 in a format of a data table or the like and referred to by the consistency judging unit 111 when necessary. As a judgment algorithm in the consistency judging processing, it is possible to adopt various methods for judging general misdescriptions (a grammar check algorithm, etc.).

If it is judged by the consistency judging unit 111 that the arrangement of the objects or the rendered contents are inconsistent, the notifying unit 112 causes the display unit 701 to display a notification screen indicating that the arrangement of the objects or the rendered contents are inconsistent. The notification by the notifying unit 112 does not always have to be performed by the screen display on the display unit 701. It goes without saying that, for example, it is also possible to cause the image forming unit 300 to print and output notification contents or provide a speaker or the like that can output sound in the image processing apparatus 1c to perform notification by sound. Described contents of warning description displayed on a screen when the notification by the notifying unit 112 is performed, a position where the warning description is performed on the document, a record of a judgment result of the consistency judgment, and image data for identifying warning notification described together with the warning description can be stored in, for example, the database 3.

The notification by the notifying unit 112 does not always have to be notification in a sentence exactly indicating that the arrangement of the objects or the rendered contents are inconsistent. For example, concerning an object portion including inconsistency of described contents or rendered contents, display target objects are highlighted by changing at least one of content of a character, a style of the character, the thickness of the character, the tilt of the character, a shape of a figure, the thickness of a line, luminance, size, movement, color, chroma, a contrast value, and the like to realize the notification by the notifying unit 112.

Operations of the image processing apparatus 1c according to this embodiment are explained in detail below.

FIG. 16 is a diagram of an example of an application form in which check items are checked by the user.

When the user fills in the application form including the check items shown in FIG. 16, because of the characteristic of the application form, description may be inconsistent (e.g., plural items are checked in an application form in which only one item can be checked or check content in a certain item is inconsistent with another item).

In general, such a description mistake is checked by the user, a clerk at the counter, or the like. However, it is likely that the description mistake is overlooked because of a human error or the like caused by misunderstanding of the user, inexperience in job of the clerk, or the like. Therefore, it is necessary to establish a mechanism that can easily find, even if there is the check mistake by the user or the clerk at the counter described above, a description mistake of an application sheet and easily correct content of the mistake.

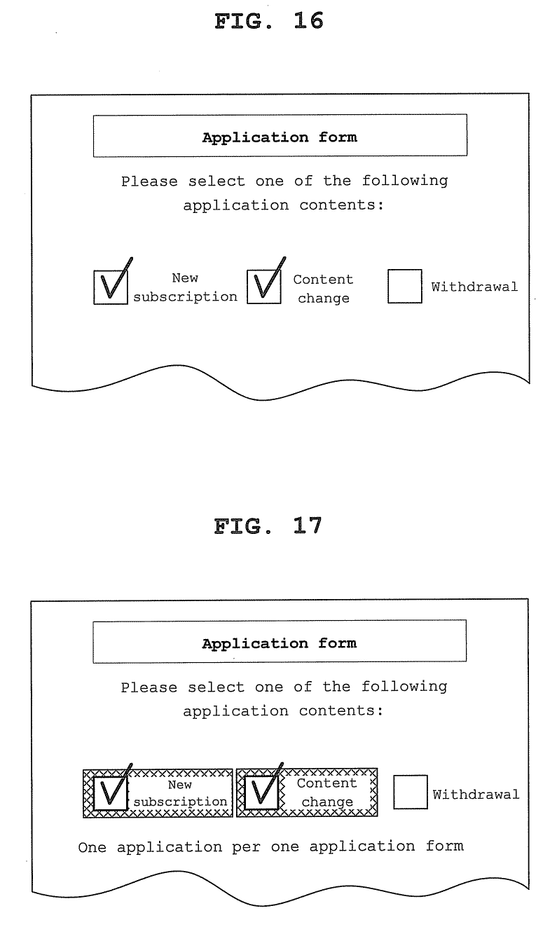

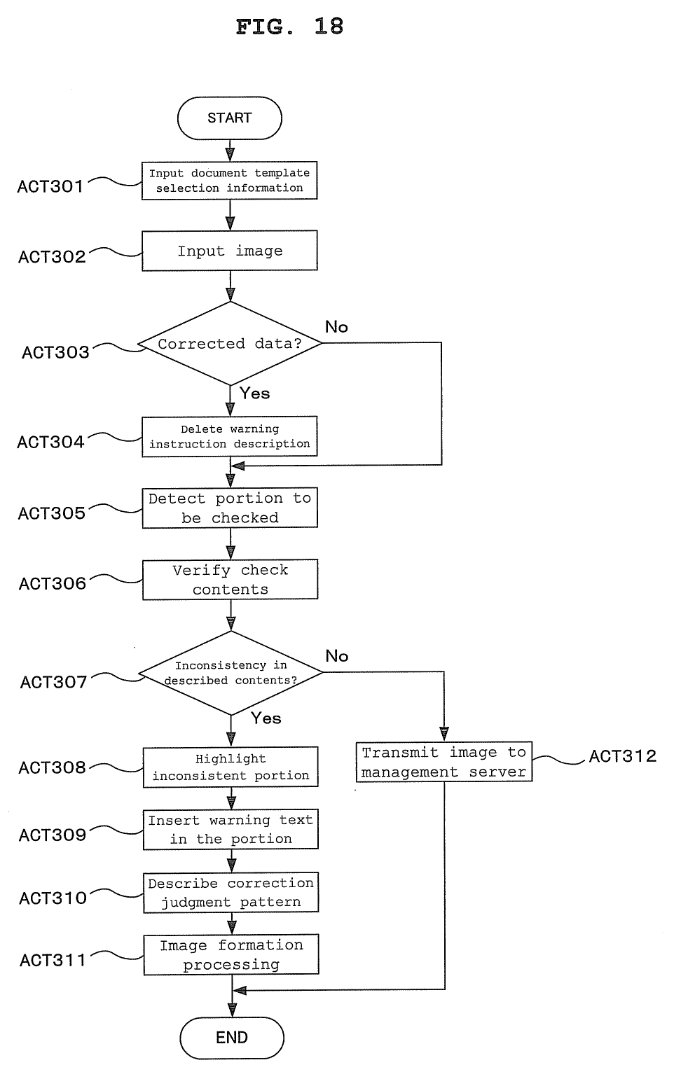

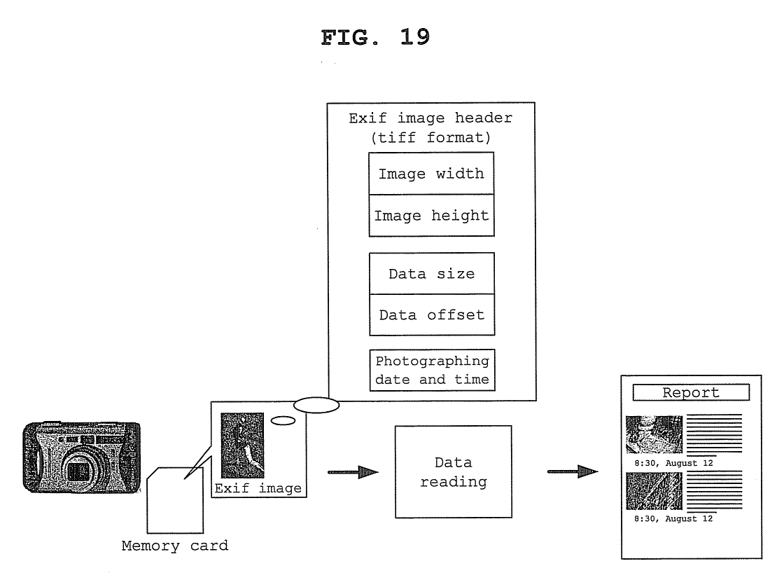

In this embodiment, for example, in the application form having the check items shown in FIG. 16, if it is judged by the consistency judging unit 111 that the user checks the items by mistake regardless of the fact that the user is not allowed to simultaneously check plural items, as shown in FIG. 17, the notifying unit 112 causes the display unit 701 to highlight a place of the mistake in a document image. Further, the notifying unit 112 causes the image forming unit 300 to print and output a document image of the application form in which the mistake is also described and urges the user to correct the described contents of the application form.

In this embodiment, as explained in the second embodiment, it is possible to separately apply image processing to respective display target objects included in the document image and merge and output the display target objects. Therefore, concerning the description mistake of the application form, scanned data for a place without a description mistake is temporarily stored in the database 4 and the user is urged to correct only a place of the description mistake on the display unit 701. This makes it possible to later merge image data obtained by scanning corrected described contents obtained by urging the user to correct the described contents and image data corresponding to a portion of the correct described contents temporarily stored in the database 4 or the like to complete the application form without a description mistake.

In this way, concerning the corrected described contents obtained by urging the user to correct described contents, the user is caused to directly perform correction on the application form printed and outputted in a state including a place of a problem such as a description mistake without requesting the user to describe a portion with correct described contents again. This makes it possible to efficiently perform correction of the described contents without rewriting the entire application form. It goes without saying that, for example, if corrected contents are inconsistent in a relation with new other items, it is possible to repeat the check and the correction with a minimum correction burden.

FIG. 18 is a flowchart of an example of a flow of processing (an image processing method) in the image processing apparatus 1c according to the third embodiment.

First, a target document scanned by the image scanning unit 200 is digitized and stored in the memory 802, the database 4, or the like of the image processing apparatus 1c (ACT 301 and ACT 302).

If the document scanned by the image scanning unit 200 is a document already corrected (ACT 303, Yes), a warning instruction description registered in the database 3 in association with the document is deleted (ACT 304).

On the other hand, if the document scanned by the image scanning unit 200 is not the corrected document (ACT 303, No), the processing proceeds to Act 305.

Subsequently, the consistency judging unit 111 extracts a place as a target of consistency check in a document image of the target document (ACT 305) and judges consistency of the place (ACT 306).

If it is judged that there is no inconsistency or problem in the described contents or rendered contents of the target document as a result of the judgment processing by the consistency judging unit 111 (ACT 307, No), it is considered that there is no problem in the described contents of the document and the document image scanned from the document is stored in the database 4 (ACT 312).

On the other hand, if it is judged that there is inconsistency or a problem in the described contents or the rendered contents in the scanned document (ACT 307, Yes), the notifying unit 112 causes the display unit 701 to highlight an area or a display target object judged as including the problem in the described contents or the rendered contents (ACT 308). The notifying unit 112 acquires a warning sentence corresponding to the description mistake (ACT 309) and a correction ID given to the document including the description mistake from the database 3. The notifying unit 112 causes the image forming unit 300 to print and output, as an image form for correction, a document image with the acquired information described in the place of the description mistake (ACT 310 and ACT 311).

The user corrects the contents of the place required to be corrected in the image form for correction outputted as explained above and causes the image scanning unit 200 to scan the document again.

The consistency judging unit 111 performs the judgment processing again for presence or absence of a description mistake in the document scanned again and judges whether an ID is written in the document and the ID is given by the image processing apparatus 1c.

If the ID included in the document image is given by the image processing apparatus 1c in the past, the consistency judging unit 111 reads out information concerning an area of a place of a description mistake stored in the database 3 in association with the ID and overwrites the area with a background image to erase character information.

In this way, according to the third embodiment of the present invention, an error in described contents or rendered contents in a document is automatically detected and a place of the error is clearly shown. This makes it possible to reduce a burden on the user. Consequently, it is possible to reduce labor and time in document preparation. Further, even a user without knowledge of image processing can create a document image of a suitable image quality.

### Fourth Embodiment

A fourth embodiment of the present invention is explained below.

The fourth embodiment is a modification of the third embodiment. In this embodiment, components having functions same as those of the sections explained in the first to third embodiments are denoted by the same reference numerals and signs and explanation of the components is omitted.

FIG. 19 is a conceptual diagram for explaining an image processing system according to the fourth embodiment.

In the fourth embodiment, for example, concerning a job flow for reporting the progress of a job using a report material in which photographs are inserted, processing for causing a user to select necessary ones out of taken photographs and automatically preparing a report form on the basis of photographing date and time information and the like included in an Exif (Exchangeable Image File Format) header of data of these photographs is explained.

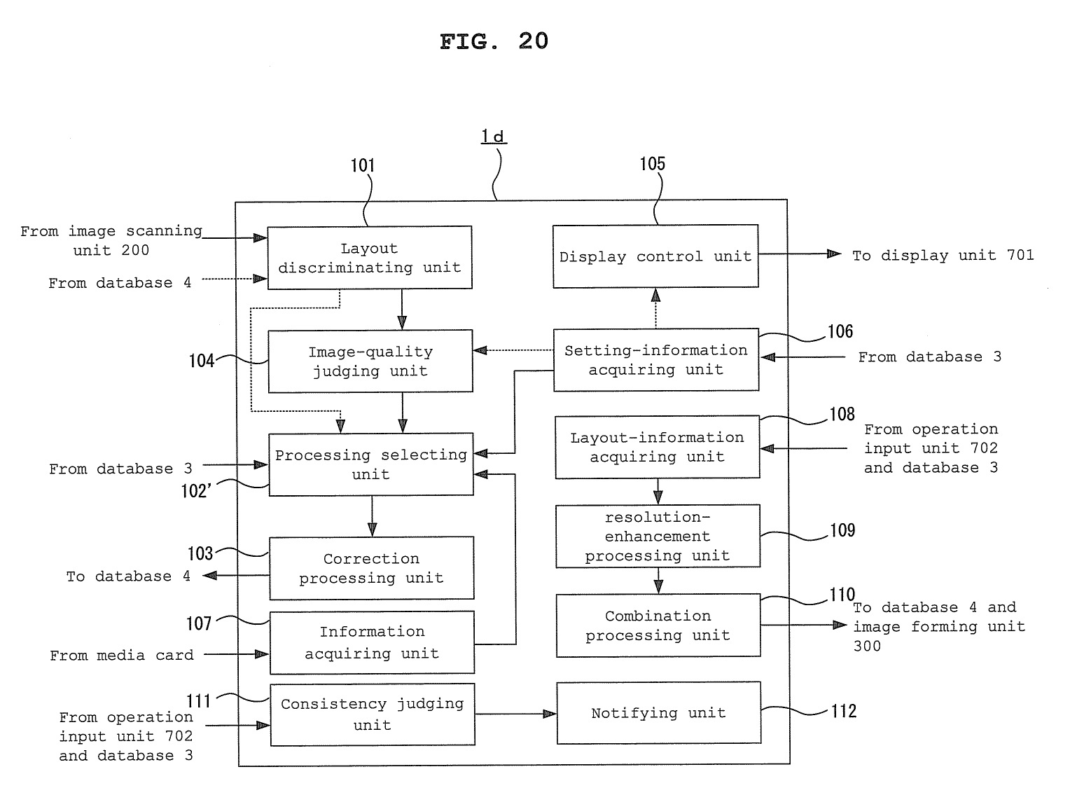

FIG. 20 is a functional block diagram for explaining a configuration of an image processing apparatus 1d according to the fourth embodiment. The image processing apparatus 1d according to the fourth embodiment further includes, in addition to the functions of the image processing apparatus 1c according to the second embodiment, an information acquiring unit 107.

Functions of a processing selecting unit 102′ and the image acquiring unit 107 in the image processing apparatus 1d according to this embodiment are explained in detail.

The information acquiring unit 107 has a function of acquiring, among plural objects included in a correction target document image, the information of objects (mainly data of photograph images) associated with at least one of Exif information, file header information, information concerning a scanner model, and character encode of a text area. For example, if photograph image data is acquired from a storage medium such as a flash memory, the Exif information is also acquired from the storage medium via an I/F together with the photograph image data.

The processing selecting unit 102′ can change, on the basis of the information acquired by the information acquiring unit 107, an algorithm or processing parameters of image processing applied to the objects.

In this embodiment, for example, if it is detected on the image processing apparatus 1d side that a flash memory is connected to the image processing apparatus 1d, image data stored in the flash memory are scanned and displayed on the display unit 701.

The user can select, using the operation input unit 702, desired image data out of the plural image data displayed on the display unit 701. The information acquiring unit 107 reads out, concerning the selected image, information concerning photographing date and time from the Exif information and describes the information in a date field in a form registered in advance. In this case, in the image processing apparatus 1d, appropriate image processing is applied to the selected image data and the image data subjected to the processing is arranged in the form (see FIG. 19).

The processing selecting unit 102′ in the image processing apparatus 1d according to this embodiment refers to, on the basis of the date information associated with the photograph data read out from the recording medium such as the flash memory, a correspondence table of dates and parameters of image processing for performing brightness correction and reads out parameters related to execution of image processing from, for example, the database 3.

The correspondence table of dates and image processing parameters for performing brightness correction specifies rules that, for example, if a photographing date teaches that a photograph image is taken on a cloudy day, photographing environment of the photograph image is estimated as dark environment and image processing for increasing brightness is applied to the photograph image.

Besides, it is also possible to acquire photographing time of a photograph image using the information acquiring unit 107 and, if the time is the night, estimate that photographing environment of the photograph image is dark environment, and apply image processing for increasing brightness to the photograph image.

It is also possible to acquire, by the information acquiring unit 107, position information (latitude, longitude, and altitude) acquired from a GPS when a photograph image is taken and apply image processing such as brightness correction corresponding to photographing environment of the photograph image to the photograph image.

Concerning a photograph image or the like taken in a room, even if photographing time is the night, it is possible that the photograph image is taken in bright environment because of the influence of illumination or the like. Taking such possibility into account, the processing selecting unit 102′ and the correction processing unit 103 may perform automatic correction for brightness or the like based on the time and position information only when the photograph image is highly likely to be taken outdoors judging from the position information acquired from the GPS, date and time, and a schedule.

Subsequently, the correction processing unit 103 applies image processing including brightness correction to the photograph image selected as explained above.

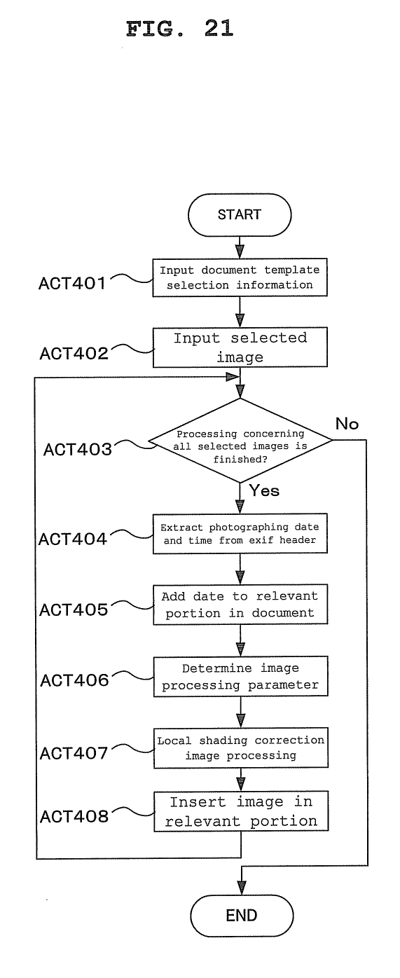

FIG. 21 is a flowchart of an example of a flow of processing (an image processing method) in the image processing apparatus 1d according to the fourth embodiment.

First, if desired photograph image data is inputted from, for example, a flash memory (ACT 401 and ACT 402), the information acquiring unit 107 acquires Exif data associated with the selected photograph image data from the flash memory or the like. The information acquiring unit 107 extracts information concerning photographing data and time of the associated photograph image data from the Exif information (ACT 404).

The correction processing unit 103 inserts the information concerning the photographing date and time acquired as explained above in a relevant place in a desired form in which the selected photograph image data is to be arranged (ACT 405). The desired form is stored in, for example, the database 3 or 4.

The processing selecting unit 102 determines, on the basis of, for example, the information concerning the photographing date and time, parameters for image processing that should be applied to the photograph image data corresponding to the information (ACT 406).

The correction processing unit 103 applies, using the parameters selected in this way, image processing such as local brightness correction to a specific area (e.g., an area corresponding to a face) in the photograph image (ACT 407).

The correction processing unit 103 inserts the thus corrected photograph image data in a desired position of a form in which the photograph image data should be inserted (see FIG. 19).

In this way, the image processing apparatus 1d repeats, for all the selected image data, the series of processings from the readout of data in the Exif format to the image processing (ACT 403). After the processing for all the selected images is finished, the image processing apparatus 1d notifies the finish of the processing.

As explained above, with the image processing apparatus 1d according to the fourth embodiment, concerning a work flow for preparing a report using photograph image data and moving image data photographed by a digital camera or the like, it is possible to realize image correction such as brightness correction by using appropriate parameters corresponding to the insertion of a date in a document using Exif information and photographing time and environment. Consequently, it is possible to reduce time and labor for document preparation. Even a user without knowledge of image processing can prepare a document including photograph images of a suitable image quality.

In the example explained in this embodiment, photograph image data to be subjected to correction processing is acquired from the flash memory. However, the present invention is not limited to this. Photograph image data and metadata such as Exif data associated with the photograph image data only have to be eventually acquired in the image processing apparatus 1d. Therefore, for example, photograph image data may be acquired from an external apparatus that can communicate with the image processing apparatus 1d via a network cable such as a USB cable or a LAN cable.

In the example explained in this embodiment, photograph image data and metadata such as Exif data corresponding to the photograph image data are integrally stored in the storage area. However, the present invention is not limited to this. For example, photograph image data and metadata and the like corresponding to the photograph image data may be stored in separate storage areas as long as the photograph image data and the metadata and the like can be finally associated with each other.

It is also possible to perform switching of presence or absence of application of high definition processing on the basis of resolution information of Exif information (an Exif header) associated with display target object. It is also conceivable to automatically perform adjustment of a white balance on the basis of GPS information and time information of the Exif header.

If information concerning a scanner model is associated with, as PDF header information, a document image or a display target object included in the document image, it is also conceivable to apply noise removal processing to the entire document image or the display target object based on the information. Such processing can be adopted, for example, when a PDF document image scanned by a scanner is directly printed using a flash memory or the like.

If information concerning character encode of a PDF text area is associated with a document image or a display target object included in the document image, for example, since the density of characters is high if the characters are Chinese characters, it is possible to apply thinning processing for suppressing deformation. Since the density of characters is low if the characters are alphabets, it is possible to apply processing for clearly showing the characters by thickening the characters.

In this way, according to the fourth embodiment, concerning a work flow for preparing a report using photographs taken by a digital camera or the like, it is possible to realize brightness correction by using appropriate parameters corresponding to date insertion in a document using metadata such as Exif information and photographing time.

The respective acts in the processing in the image processing apparatus according to each of the embodiments are realized by causing the CPU 801 to execute an image processing program stored in the memory 802.

Moreover, programs for causing a computer configuring the image processing apparatus to execute the respective acts can be provided as an image processing program. In the example explained in the embodiments, the program for realizing the functions for carrying out the invention is recorded in advance in the storage area provided in the apparatus. However, the present invention is not limited to this. The same program may be downloaded through a network to the apparatus or a computer readable recording medium having the same program stored therein may be installed in the apparatus. The recording medium may be of any form as long as it can store the program and can be read by the computer. Specific, examples of the recording medium include internal storage devices mounted in the computer such as a ROM and a RAM, portable storage media such as a CD-ROM, a flexible disk, a DVD disk, a magneto-optical disk, and an IC card, a database that stores a computer program, other computers and databases for the computers, and a transmission medium on a line. The functions that are obtained by install in advance or download in this way may be realized by cooperation with an OS (operating system) in the apparatus.

The programs in the embodiments include those from which an execution module is dynamically generated.

The image processing apparatus according to each of the embodiments is realized by an MFP (Multi Function Peripheral) However, the present invention is not limited to this.

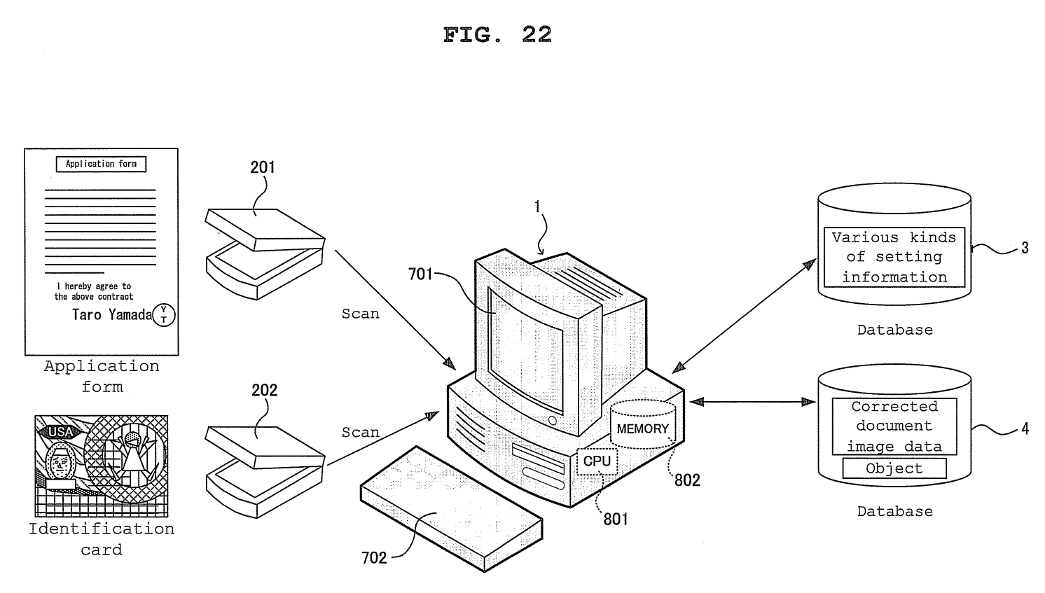

FIG. 22 is a diagram of a configuration example in which the image processing apparatus according to the present invention is realized by a PC (Personal Computer). The image processing system in this case can include the image processing apparatus 1, the scanners 201 and 202, the database 3, and the database 4. Specifically, the scanner 201 scans, for example, an image of an application form signed and sealed by an applicant and passes the generated image data to the image processing apparatus 1. The scanner 202 scans, for example, an image of an identification card of the applicant and passes the generated image data to the image processing apparatus 1.

In the configuration shown in FIG. 22, the scanner for scanning the application form and the scanner for scanning the certificate document are separately provided. However, the present invention is not limited to this. For example, it goes without saying that it is possible to scan and digitize plural kinds of originals with one scanner to transmit to the image processing apparatus 1 as separate electronic data.

Besides, it goes without saying that, as the image processing apparatus according to the present invention, it is possible to adopt an apparatus such as an MMK (Multi Media Kiosk) that can acquire a document image and apply predetermined image processing to the acquired document image.

In the example explained in each of the embodiments, the components of the image processing apparatus according to the embodiment are arranged in the single apparatus. However, the present invention is not limited to this. For example, the components may be distributed and arranged in plural apparatuses as long as, in the entire system, essential requirements of the image processing apparatus according to the present invention are satisfied and the functions of the image processing apparatus are realized.

The present invention has been explained in detail above. However, it would be obvious to those skilled in the art that various modifications and alterations are possible without departing from the spirit and the scope of the present invention.

As explained above in detail, according to the present invention, it is possible to provide an image processing technique that can separately apply, concerning a document image including plural objects, appropriate image processing to each of the objects included in the document image.

What is claimed is:

1. An image processing apparatus that applies image processing to a document image including plural objects, the image processing apparatus comprising:
a layout discriminating unit that discriminates to which of plural kinds of predetermined layouts a layout of objects in a correction target document image corresponds;
a processing selecting unit that selects, on the basis of the layout discriminated by the layout discriminating unit, predetermined image processing associated with positions and types of the respective objects in the discriminated layout; and
a correction processing unit that applies the image processing selected for the types of the respective objects by the processing selecting unit to the respective objects corresponding to the types in the correction target document image.

2. The apparatus according to claim 1, further comprising an image-quality judging unit that judges, on the basis of at least one of luminance values and color values of pixels included in each of the plural objects included in the correction target document image and shape of a part of the object or the entire object, image qualities of the respective objects, wherein
the processing selecting unit selects, on the basis of the judgment result in the image-quality judging unit, an algorithm or processing parameters of image processing that should be applied to the objects.

3. The apparatus according to claim 1, further comprising an image-quality judging unit that judges, on the basis of at least one of luminance values and color values of pixels included in an object included in the correction target document image and a shape of a part of the object or the entire object, an image quality of the object, wherein
the processing selecting unit determines, on the basis of the judgment result in the image-quality judging unit, presence or absence of application of image processing to the object.

4. The apparatus according to claim 1, wherein the image processing is at least one of high definition processing, smoothing processing, noise removal processing, thinning and thickening processing, white balance correction processing, brightness correction processing, chroma correction processing, partial brightness correction processing, local color conversion processing, hand-written character discrimination processing, line thickness detection processing, and face detection processing.

5. The apparatus according to claim 1, wherein the processing selecting unit selects, on the basis of an image quality of a first object judged by the image-quality judging unit, an algorithm or processing parameters of image processing applied to a second object different from the first object.

6. The apparatus according to claim 1, wherein an object included in the document image includes at least one of a character, a sign, a line, a figure, a photograph, an image, and a background.

7. The apparatus according to claim 1, wherein
the processing selecting unit selects, for a first object included in a document image and including at least one of a character, a sign, a line, and a figure, processing for setting resolution lower than that of a predetermined second object having importance higher than that of the first object, and
the correction processing unit applies the image processing selected by the processing selecting unit to each of the first and second objects.

8. The apparatus according to claim 1, further comprising an information acquiring unit that acquires, among plural objects included in a correction target document image, the information of objects associated with at least one of Exif information, file header information, information concerning a scanner model, and character encode of a text area, wherein
the processing selecting unit changes, on the basis of the information acquired by the information acquiring unit, an algorithm or processing parameters of image processing applied to the objects.

9. The apparatus according to claim 1, further comprising:
a consistency judging unit that judges consistency of arrangement of objects or rendered contents in a correction target document image; and
a notifying unit that notifies, if it is judged by the consistency judging unit that the arrangement of the objects or the rendered contents are inconsistent, that the arrangement of the objects or the rendered contents are inconsistent.

10. The apparatus according to claim 1, further comprising:
a display control unit that causes a display unit to display a selection screen on which it is possible to select, for each of the predetermined layouts, image processing that should be applied to objects included in a correction target document image; and
a setting-information acquiring unit that acquires, on the basis of contents of the screen display by the display control unit, information concerning setting operation inputted by a user, wherein
the processing selecting unit selects, on the basis of the information acquired by the setting-information acquiring unit, image processing set for the respective objects.

11. An image processing apparatus that combines plural objects to form a document image, the image processing apparatus comprising:
a layout-information acquiring unit that acquires information concerning layouts of objects in a document image that should be formed;
a resolution-enhancement processing unit that enhancing a first resolution of a first object to a second resolution of a second object, which is higher than the first resolution; and
a combination processing unit that combines the second object and the first object with enhanced resolution into a single document image on the basis of the information acquired by the layout-information acquiring unit.

12. An image processing method for applying image processing to a document image including plural objects, the image processing method comprising:
discriminating to which of plural kinds of predetermined layouts a layout of objects in a correction target document image corresponds;
selecting, on the basis of the discriminated layout, predetermined image processing associated with positions and types of the respective objects in the discriminated layout; and
applying the image processing selected for the types of the respective objects to the respective objects corresponding to the types in the correction target document image.

13. The method according to claim 12, further comprising:
judging, on the basis of at least one of luminance values and color values of pixels included in an object included in the correction target document image and a shape of a part of the object or the entire object, an image quality of the object; and
selecting, on the basis of the result of the judgment, an algorithm or processing parameters of image processing that should be applied to the object.

14. The method according to claim 12, further comprising:
judging, on the basis of at least one of a luminance value, a color value, and a shape of each of plural objects included in a correction target document image, image qualities of the respective objects; and
determining, on the basis of a result of the judgment, presence or absence of application of image processing to the respective objects.

15. The method according to claim 12, further comprising selecting, on the basis of a judged image quality of a first object, an algorithm or processing parameters of image processing applied to a second object different from the first object.

16. The method according to claim 12, further comprising:
selecting, for a first object including at least one of a character, a sign, a line, and a figure included in a document image, processing for setting resolution lower than that of a predetermined second object having importance higher than that of the first object; and
applying the selected image processing to each of the first and second objects.

17. The method according to claim 16, further comprising:
applying image processing for enhancing resolution of the first object subjected to the image processing to resolution same as that of a second object; and
combining the second object and the first object enhanced in resolution on the basis of the discriminated layout.

18. The method according to claim 12, further comprising:
acquiring, among plural objects included in a correction target document image, the information of objects associated with at least one of Exif information, file header information, information concerning a scanner model, and character encode of a text area; and
changing, on the basis of the acquired information, an algorithm or processing parameters of image processing applied to the objects.

19. The method according to claim 12, further comprising:
judging consistency of arrangement of objects or rendered contents in a correction target document image; and
notifying, if it is judged that the arrangement of the objects or the rendered contents are inconsistent, that the arrangement of the objects or the rendered contents are inconsistent.

20. The method according to claim 12, further comprising:
causing a display unit to display a selection screen on which it is possible to select, for each of the predetermined layouts, image processing that should be applied to objects included in a correction target document image;
acquiring, on the basis of contents of the screen display, information concerning setting operation inputted by a user; and
selecting, on the basis of the acquired information, image processing set for the respective objects.
